(19) United States
(12) Patent Application Publication
(10) Pub. No.: US 2026/0348465 A1
(43) Pub. Date: Nov. 5, 2026

(54) Transmission and Drive Device for a Motor Vehicle

(71) Applicant: ZF Friedrichshafen AG, Friedrichshafen (DE)

(72) Inventors: Stefan BECK, Eriskirch (DE); Matthias REISCH, Ravensburg (DE); Eckhardt LÜBKE, Friedrichshafen (DE); Domenico BARTILUCCI, Friedrichshafen-Fischbach (DE); Tamas GYARMATI, Bermatingen (DE)

(21) Appl. No.: 19/118,712

(22) PCT Filed: Sep. 21, 2023
(86) PCT No.: PCT/EP2023/076035

§ 371 Date: Apr. 4, 2025

(30) Foreign Application Priority Data
Oct. 6, 2022 (DE) 102022210573.7

(51) Int. Cl. F16H 48/10; F16H 37/08; F16H 48/22; F16H 48/24

(52) U.S. Cl. CPC F16H 48/10; F16H 37/082; F16H 48/22; F16H 48/24

(57) ABSTRACT

A transmission for a motor vehicle includes a first planetary gear set having first gear set elements including a first element, a second element, and a third element, where the first planetary gear set is a minus planetary gear set. The transmission further includes a drive shaft for connecting the transmission to a drive unit of the motor vehicle, a first output shaft connecting the transmission to a wheel of the motor vehicle, a second output shaft connecting the transmission to another wheel of the motor vehicle, and a switching element. One of the first gear set elements is rotationally fixedly connected to the first output shaft, another of the first gear set elements is rotationally fixedly connected to the second output shaft, and a further one of the first gear set elements is connectable to one of the first and second output shafts via the switching element.

### CROSS-REFERENCE TO RELATED APPLICATION

The present application is related and has right of priority to German Patent Application No. 10 2022 210 573.7 filed on Oct. 6, 2022 and is a nationalization of PCT/EP 2023/076035 filed in the European Patent Office on Sep. 21, 2023, both of which are incorporated by reference in their entirety for all purposes.

### FIELD OF THE INVENTION

The invention relates generally to a transmission for a motor vehicle. Furthermore, the invention relates generally to a drive device having such a transmission.

### BACKGROUND

For example, DE 10 2013 215 877 A1 discloses an epicyclic gear transmission for branching the drive power present at a power input to a first and to a second power output in conjunction with a reduction of the output rotational speed to a rotational speed level below the drive rotational speed at the power input. The epicyclic gear transmission includes a first transmission stage which has a first sun gear, a first planetary gear set, a first planet carrier and a first ring gear, a second transmission stage which has a second sun gear, a second planetary gear set, a second planet carrier and a second ring gear, and a third planetary stage which has a third sun gear, a third planetary gear set and a third planet carrier. The first sun gear is configured as a power input, the first planet carrier is coupled in a rotationally fixed manner to the second sun gear, the second planet carrier is fixed in a stationary manner, the first ring gear is coupled to the third sun gear, the first power output takes place via the third transmission stage, and the second power output takes place via the second ring gear of the second transmission stage.

### SUMMARY OF THE INVENTION

The object of the present invention consists in providing an alternative transmission which includes, in particular, an improved power density and an improved efficiency and a differential locking action.

A transmission according to the invention for a motor vehicle has a first planetary gear set, a second planetary gear set and a third planetary gear set, wherein each planetary gear set includes a first element, a second element and a third element, exactly one drive shaft for connecting the transmission to a drive unit of the motor vehicle, a first output shaft and a second output shaft each for connecting the transmission to a wheel of the motor vehicle, a first coupling shaft and a second coupling shaft each for connecting two elements of two planetary gear sets in a rotationally fixed manner, and a switching element for transmitting a torque between one of the two output shafts and the second coupling shaft,
wherein one of the elements of the second planetary gear set is connected to the drive shaft in a rotationally fixed manner, wherein another of the elements of the second planetary gear set is connected to the first coupling shaft in a rotationally fixed manner, wherein another of the elements of the second planetary gear set is connected to the second coupling shaft in a rotationally fixed manner,
wherein one of the elements of the third planetary gear set is connected to the first coupling shaft in a rotationally fixed manner, wherein another of the elements of the third planetary gear set is connected to a stationary component in a rotationally fixed manner, wherein another of the elements of the third planetary gear set is connected to the second output shaft in a rotationally fixed manner,
wherein one of the elements of the first planetary gear set is connected to the second coupling shaft in a rotationally fixed manner, wherein another of the elements of the first planetary gear set is connected to the first output shaft in a rotationally fixed manner, wherein another of the elements of the first planetary gear set is connected to the second output shaft in a rotationally fixed manner.

A “connection” of a device or of an element to the transmission is understood to mean that the transmission, in particular the corresponding shaft of the transmission, is connected either directly, for example in a rotationally fixed manner, to the device or to the element, or indirectly, for example via at least one further component, in particular via at least one further shaft or a further gearwheel. If two shafts are connected to one another in a rotationally fixed manner, they rotate together in one direction of rotation at a rotational speed. In particular, the connection may also take place via a switching element, as a result of which a drive-effective coupling and decoupling of the device or of the element to the corresponding shaft of the transmission is possible.

A “shaft” is not to be understood exclusively as meaning, for example, a cylindrical, rotatably mounted transmission element for transmitting torques, but rather is also to be understood as meaning general connecting elements which connect individual components or elements to one another, in particular connecting elements which connect a plurality of elements to one another in a rotationally fixed manner. Two shafts connected to one another in a rotationally fixed manner may be formed in one piece.

A “stationary component” is to be understood as meaning a non-rotating component of the transmission. For example, the stationary component is a housing or housing section of the transmission. Alternatively, the stationary component is a shaft fixed to the housing.

Consequently, the second planetary gear set is connected or is connectable at least indirectly or directly to the drive unit via the drive shaft, and is connected to the third planetary gear set via the first coupling shaft and is connected to the first planetary gear set via the second coupling shaft. Furthermore, the third planetary gear set is connected to the housing in a rotationally fixed manner and is connected to the first planetary gear set via the second output shaft. Furthermore, the first planetary gear set is connected to the first output shaft. The first planetary gear set is connected or is connectable at least indirectly or directly to a first wheel of the motor vehicle via the first output shaft. Furthermore, the first and the third planetary gear set are connected or is connectable at least indirectly or directly to a second wheel of the motor vehicle via the second output shaft.

For example, the drive unit is an electric machine which is operable as a drive motor for driving the vehicle and as a generator for recuperating electrical energy. For this purpose, the electric machine is electrically connected to an electrical energy store. The electric machine has a rotor and a stator, wherein the rotor is connected to a rotor shaft in a rotationally fixed manner. The rotor shaft of the electric machine is connected at least indirectly or directly to the drive shaft. For example, the rotor shaft of the electric machine is connected to the drive shaft via at least one further shaft, via a plurality of gearwheels and/or via a traction means. The electric machine may be arranged on a common axis of rotation with the transmission and therefore coaxial with respect to the drive shaft, wherein the rotor shaft is then preferably connected to the drive shaft in a rotationally fixed manner. Alternatively, the electric machine may be axially parallel with respect to the drive shaft, wherein the rotor shaft is then connected indirectly to the drive shaft. Alternatively, the drive unit may be an internal combustion engine with a crankshaft.

A “switching element” is to be understood as meaning a switchable device which has at least one open state and one closed state, wherein, in the open state, two shafts connected thereto can rotate freely, and wherein, in the closed state, the two shafts are connected to one another in a rotationally fixed manner.

According to a preferred aspects of one embodiment, the switching element in a closed state connects the third element of the first planetary gear set and the first element of the first planetary gear set to one another in a rotationally fixed manner. According to a preferred aspects of one embodiment, the switching element in a closed state connects the second element of the first planetary gear set and the first element of the first planetary gear set to one another in a rotationally fixed manner.

Consequently, the first planetary gear set is blocked via the switching element. In other words, two elements of the first planetary gear set, for example the sun gear and the ring gear or the sun gear and the planet carrier, are connected in a rotationally fixed manner, with the result that the first planetary gear set rotates in a block and has the transmission ratio of 1. As a result of one of these elements of the first planetary gear set being connected either to the first output shaft or to the second output shaft, a differential locking action is also generated by the switching element. The switching element can be switched by an actuator. A “differential locking action” is to be understood as meaning a locking action between the two output shafts. The switching element may be a frictionally locking or positively locking switching element. For example, a positively locking switching element is a claw clutch. By positively locking switching element, the efficiency of the transmission is increased on account of reduced drag losses. In particular, positively locking switching elements are more compact and efficiency-optimized and have a cost advantage in relation to frictionally locking switching elements. However, slip operation, i.e. a limited locking action under differential rotational speed, is not possible with positively locking switching elements. For example, a frictionally locking switching element includes a plurality of plates or at least one conical friction surface. In the case of a frictionally locking switching element, the latter is actuatable via an actuator or mechanically, in particular by using axial forces from helical toothings. An actuator may be fixed to the housing or co-rotating.

According to a preferred aspect of one embodiment, the first element of the second planetary gear set is connected to the input shaft in a rotationally fixed manner, wherein the second element of the second planetary gear set is connected to the first coupling shaft in a rotationally fixed manner, wherein the third element of the second planetary gear set is connected to the second coupling shaft in a rotationally fixed manner, wherein the first element of the third planetary gear set is connected to the first coupling shaft in a rotationally fixed manner, wherein the second element of the third planetary gear set is connected to a stationary component in a rotationally fixed manner, wherein the third element of the third planetary gear set is connected to the second output shaft in a rotationally fixed manner, wherein the first element of the first planetary gear set is connected to the second coupling shaft in a rotationally fixed manner, wherein the second element of the first planetary gear set is connected to the first output shaft in a rotationally fixed manner, wherein the third element of the first planetary gear set is connected to the second output shaft in a rotationally fixed manner. In this respect, reference will be made to the aspects of according to FIGS. 4, 5 and 6 below.

According to a preferred aspects, the first element of the second planetary gear set is connected to the input shaft in a rotationally fixed manner, wherein the second element of the second planetary gear set is connected to the second coupling shaft in a rotationally fixed manner, wherein the third element of the second planetary gear set is connected to the first coupling shaft in a rotationally fixed manner, wherein the first element of the third planetary gear set is connected to the first coupling shaft in a rotationally fixed manner, wherein the second element of the third planetary gear set is connected to a stationary component in a rotationally fixed manner, wherein the third element of the third planetary gear set is connected to the second output shaft in a rotationally fixed manner, wherein the first element of the first planetary gear set is connected to the second output shaft in a rotationally fixed manner, wherein the second element of the first planetary gear set is connected to the first output shaft in a rotationally fixed manner, wherein the third element of the first planetary gear set is connected to the second coupling shaft in a rotationally fixed manner. In this respect, reference will be made to aspects according to FIGS. 7 and 8 below.

According to a preferred aspect, the first element of the second planetary gear set is connected to the input shaft in a rotationally fixed manner, wherein the second element of the second planetary gear set is connected to the first coupling shaft in a rotationally fixed manner, wherein the third element of the second planetary gear set is connected to the second coupling shaft in a rotationally fixed manner, wherein the first element of the third planetary gear set is connected to the first coupling shaft in a rotationally fixed manner, wherein the second element of the third planetary gear set is connected to a stationary component in a rotationally fixed manner, wherein the third element of the third planetary gear set is connected to the second output shaft in a rotationally fixed manner, wherein the first element of the first planetary gear set is connected to the second output shaft in a rotationally fixed manner, wherein the second element of the first planetary gear set is connected to the first output shaft in a rotationally fixed manner, wherein the third element of the first planetary gear set is connected to the second coupling shaft in a rotationally fixed manner. In this respect, reference will be made to aspects according to FIGS. 9 and 10 below.

According to a preferred aspect, the first element of the second planetary gear set is connected to the input shaft in a rotationally fixed manner, wherein the second element of the second planetary gear set is connected to the first coupling shaft in a rotationally fixed manner, wherein the third element of the second planetary gear set is connected to the second coupling shaft in a rotationally fixed manner, wherein the first element of the third planetary gear set is connected to the first coupling shaft in a rotationally fixed manner, wherein the second element of the third planetary gear set is connected to the second output shaft in a rotationally fixed manner, wherein the third element of the third planetary gear set is connected to a stationary component in a rotationally fixed manner, wherein the first element of the first planetary gear set is connected to the second coupling shaft in a rotationally fixed manner, wherein the second element of the first planetary gear set is connected to the second output shaft in a rotationally fixed manner, wherein the third element of the first planetary gear set is connected to the first output shaft in a rotationally fixed manner. In this respect, reference will be made to aspects according to FIG. 11.

According to a preferred aspect, the first element of the second planetary gear set is connected to the input shaft in a rotationally fixed manner, wherein the second element of the second planetary gear set is connected to the second coupling shaft in a rotationally fixed manner, wherein the third element of the second planetary gear set is connected to the first coupling shaft in a rotationally fixed manner, wherein the first element of the third planetary gear set is connected to the first coupling shaft in a rotationally fixed manner, wherein the second element of the third planetary gear set is connected to the second output shaft in a rotationally fixed manner, wherein the third element of the third planetary gear set is connected to a stationary component in a rotationally fixed manner, wherein the first element of the first planetary gear set is connected to the second coupling shaft in a rotationally fixed manner, wherein the second element of the first planetary gear set is connected to the second output shaft in a rotationally fixed manner, wherein the third element of the first planetary gear set is connected to the first output shaft in a rotationally fixed manner. In this respect, reference will be made to aspects according to FIG. 12.

According to a preferred aspect, two of the three planetary gear sets are arranged in a radially nested manner. In other words, the elements of the two planetary gear sets are arranged in an axially overlapping manner such that one of the two planetary gear sets is arranged on the outside and the other of the two planetary gear sets is arranged on the inside. As a result, the transmission is formed in a more compact manner, in particular in the axial direction. Preferably, the first and third planetary gear sets are arranged in a radially nested manner. Alternatively, the first and second planetary gear sets are arranged in a radially nested manner.

According to a preferred aspect, one of the two coupling shafts or one of the two output shafts is formed in one piece with the elements of the respective planetary gear sets connected to it. For example, a coupling shaft or an output shaft may be formed in one piece as an intermediate gear with two toothings, wherein an internal toothing of the intermediate gear forms a ring gear for a radially inner planetary gear set, wherein an external toothing of the intermediate gear forms a sun gear for a radially outer planetary gear set. Such an intermediate gear is also called a sun ring gear. Alternatively, a coupling shaft or an output shaft can have a toothing which forms a common ring gear for two planetary gear sets. Alternatively, a coupling shaft or an output shaft can have a toothing which forms a common sun gear for two planetary gear sets. Alternatively, a coupling shaft or an output shaft can form a common planet carrier.

According to a preferred aspect, at least one of the planetary gear sets is a minus planetary gear set, wherein the first element of the respective planetary gear set is a sun gear, wherein the second element of the respective planetary gear set is a planet carrier, wherein the third element of the respective planetary gear set is a ring gear. A plurality of planetary gears which are in toothed engagement with the sun gear and the ring gear are arranged rotatably mounted on the planet carrier.

The invention furthermore relates to a transmission for a motor vehicle having at least one first planetary gear set with a first element, a second element and a third element, wherein the first planetary gear set is a minus planetary gear set with a sun gear, a ring gear and a planet carrier, a drive shaft for connecting the transmission to a drive unit of the motor vehicle, a first output shaft and a second output shaft each for connecting the transmission to a wheel of the motor vehicle, a switching element, wherein one of the elements of the first planetary gear set is connected to the first output shaft in a rotationally fixed manner, wherein another of the elements of the first planetary gear set is connected to the second output shaft in a rotationally fixed manner, and wherein another of the elements of the first planetary gear set is connectable to one of the two output shafts via the switching element.

A drive device according to the invention has a drive unit and a transmission according to the invention. The drive unit is preferably an electric machine. Alternatively, the drive unit is an internal combustion engine. The drive unit is coaxial or axially parallel with respect to the drive shaft of the transmission. The drive power of the drive unit is fed into the transmission via the drive shaft and distributed to the two output shafts, wherein the respective output shaft is operatively connected to a respective drive wheel of a drive axle of the vehicle.

A motor vehicle according to the invention has a drive device according to the invention. In particular, the motor vehicle is an electric vehicle and has an electric drive axle with the drive device according to the invention. The above definitions and statements relating to technical effects, advantages and advantageous embodiments of the transmission according to the invention likewise apply analogously to the drive device according to the invention and to the motor vehicle according to the invention.

### BRIEF DESCRIPTION OF THE DRAWINGS

Advantageous embodiments of the invention, which are explained below, are illustrated in the drawings, wherein identical elements are provided with the same reference signs. The drawings showing:

FIG. 1 a highly abstracted schematic view of a motor vehicle with a drive device according to the invention;

FIG. 2 a highly abstracted schematic principle sketch of the drive device according to the invention;

FIG. 3 a highly abstracted schematic principle sketch of the drive device according to the invention according to an alternative embodiment;

FIG. 4 a highly abstracted schematic view of the drive device according to the invention according to a first embodiment;

FIG. 5 a highly abstracted schematic view of a drive device according to the invention according to a second embodiment;

FIG. 6 a highly abstracted schematic view of a drive device according to the invention according to a third embodiment;

FIG. 7 a highly abstracted schematic view of a drive device according to the invention according to a fourth embodiment;

FIG. 8 a highly abstracted schematic view of a drive device according to the invention according to a fifth embodiment;

FIG. 9 a highly abstracted schematic view of a drive device according to the invention according to a sixth embodiment;

FIG. 10 a highly abstracted schematic view of a drive device according to the invention according to a seventh embodiment;

FIG. 11 a highly abstracted schematic view of a drive device according to the invention according to an eighth embodiment; and

FIG. 12 a highly abstracted schematic view of a drive device according to the invention according to a ninth embodiment.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

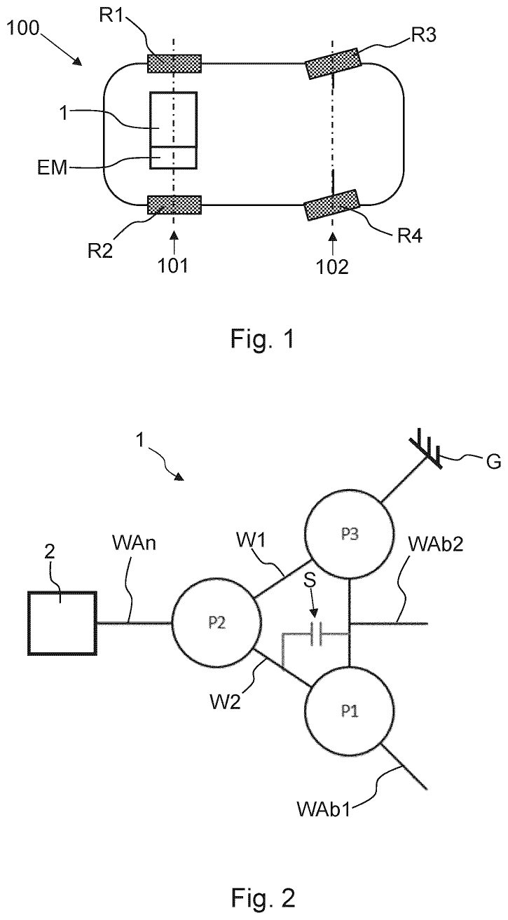

FIG. 1 shows a motor vehicle 100 with a first wheel axle 101 with two wheels R1, R2, and a second wheel axle 102 with two wheels R3, R4. In the present case, the first wheel axle 101 is a rear drive axle of the motor vehicle 100 and is equipped with a drive device according to the invention which has a single drive unit 2 (FIG. 2) as an electric machine EM and a transmission 1 as an epicyclic gear transmission. Consequently, the motor vehicle 100 is an electric vehicle. The drive device is arranged transversely to the longitudinal direction of the vehicle and is operatively connected to the wheels R1, R2 of the first wheel axle 101. In the present case, no further drive device is arranged on the second wheel axle 102, that is to say on the front axle of the vehicle 100, as a result of which costs, weight and installation space are saved. Alternatively, the drive device can be arranged on the front axle of the motor vehicle 100 instead of on the rear axle. In order to realize an all-wheel drive system, a further drive device can be arranged on the second wheel axle 102 and be operatively connected to the wheels R3, R4 of this wheel axle 102.

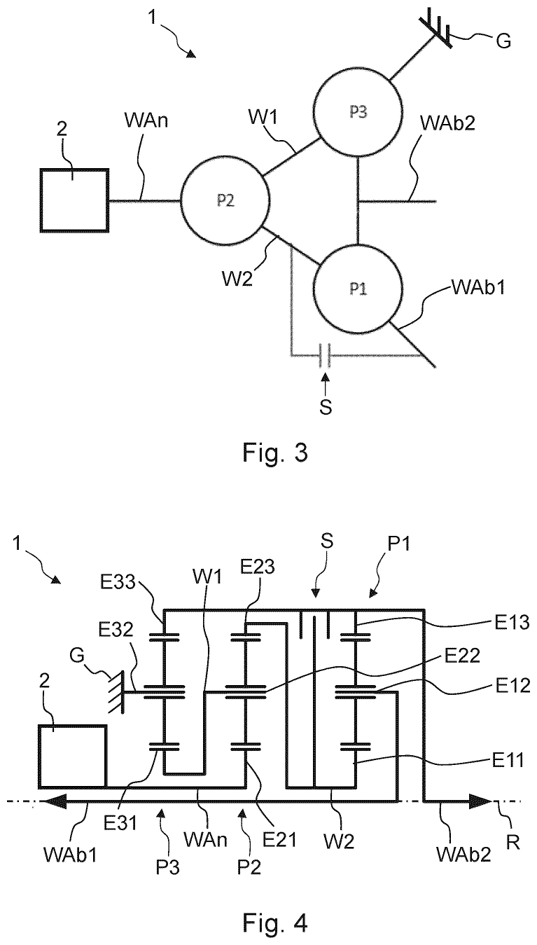

FIG. 2 and FIG. 3 each show schematically a principle sketch of the drive device according to FIG. 1. The transmission 1 of the drive device has a first planetary gear set P1, a second planetary gear set P2, and a third planetary gear set P3, which are each illustrated graphically by a circle. Each planetary gear set P1, P2, P3 has a first element, a second element and a third element, which are each indicated by three connection options to the respective planetary gear set P1, P2, P3. Furthermore, the transmission 1 has five shafts, namely a drive shaft WAn for connecting the transmission 1 to the drive unit 2, a first output shaft WAb1 and a second output shaft WAb2 each for connecting the transmission 1 to a wheel of the motor vehicle, and a first coupling shaft W1 and a second coupling shaft W2.

One of the elements of the second planetary gear set P2 is connected to the drive shaft WAn in a rotationally fixed manner (e.g., is rotationally fixedly connected to the drive shaft WAn). The second planetary gear set P2 is operatively connected to the drive unit 2 via the drive shaft WAn. In other words, at least one further shaft, a gearwheel, a switching element, or the like can be arranged in the power flow between the drive unit 2 and the drive shaft WAn. Another of the elements of the second planetary gear set P2 is connected to the first coupling shaft W1 in a rotationally fixed manner. Another of the elements of the second planetary gear set P2 is connected to the second coupling shaft W2 in a rotationally fixed manner.

One of the elements of the third planetary gear set P3 is connected to the first coupling shaft W1 in a rotationally fixed manner. Consequently, the third planetary gear set P3 is connected to the second planetary gear set P2 via the first coupling shaft W1. Another of the elements of the third planetary gear set P3 is connected to a stationary component, a housing G, of the transmission 1 in a rotationally fixed manner and is therefore prevented from rotating. Another of the elements of the third planetary gear set P3 is connected to the second output shaft WAb2 in a rotationally fixed manner.

One of the elements of the first planetary gear set P1 is connected to the second coupling shaft W2 in a rotationally fixed manner. Consequently, the first planetary gear set P1 is connected to the second planetary gear set P2 via the second coupling shaft W2. Another of the elements of the first planetary gear set P1 is connected to the first output shaft WAb1 in a rotationally fixed manner. Another of the elements of the first planetary gear set P1 is connected to the second output shaft WAb2 in a rotationally fixed manner. Consequently, the first planetary gear set P1 is connected to the third planetary gear set P3 via the second output shaft WAb2.

According to FIG. 2, the transmission 1 furthermore includes a switching element S for transmitting a torque between the second output shaft WAb2 and the second coupling shaft W2. In other words, the second coupling shaft W2 is connectable to the second output shaft WAb2 via the switching element S.

According to FIG. 3, the transmission 1 includes a switching element S for transmitting a torque between the first output shaft WAb1 and the second coupling shaft W2. In other words, the second coupling shaft W2 is connectable to the first output shaft WAb1 via the switching element S.

The switching element is provided as a differential lock and is preferably a friction clutch. For example, the friction clutch has at least two corresponding friction surfaces, that is to say a friction surface pair. For example, the friction clutch is a plate clutch and includes a plurality of friction surface pairs acting in parallel. For example, the friction surfaces are planar. Alternatively, the friction surfaces are conical, as a result of which a friction torque is increased. For example, a friction element as a friction plate or friction cone or a component axially adjacent thereto serves for axial play adjustment. Alternatively, the switching element S is a claw clutch. Alternatively, the switching element is a synchronizer. Preferably, the actuation of the switching element S takes place by a hydraulic cylinder which is arranged fixed to the housing or co-rotating. Alternatively, the actuation of the switching element S takes place electromechanically, for example via a spindle, a ramp or a lever. Alternatively, the actuation of the switching element S takes place electromagnetically. The force required for the actuation of the switching element S results at least partially or completely from an axial force of at least one helical toothing. In particular, the force flow in the first planetary gear set P1 is formed such that, in traction and in overrun mode of the drivetrain, forces from the at least one helical toothing act on the switching element S.

According to the invention, the switching element S is provided for transmitting a torque between one of the two output shafts WAb1, WAb2 and the second coupling shaft W2. In particular, one of the two output shafts WAb1, WAb2 is connected to an element, a planet carrier, of the first planetary gear set P1 in a rotationally fixed manner. The reaction torque of the drive unit 2, in sum with the housing support torque, is inversely equal in magnitude to the output torques at the two output shafts WAb1, WAb2. Consequently, no summation of the output torques takes place analogously to a differential cage at a rotating component. The sum of the two output torques is not present at any rotating component of the transmission 1. The sum of the output torques is greater in terms of magnitude than the drive torque, since it is not only a differential, but rather a step-up transmission with a differential function.

The first planetary gear set P1 rotates in a block during straight-ahead travel of the motor vehicle, with the result that the elements of the first planetary gear set P1 do not roll and as a result no corresponding losses are generated. The second planetary gear set P2 has no housing support, with the result that all three elements of the second planetary gear set P2 are rotatable. The third planetary gear set P3 has a housing support, as a result of which a torque conversion is made possible.

The three planetary gear sets P1, P2, P3 are connected to one another such that each planetary gear set P1, P2, P3 shares exactly one rotationally fixed connection with each planetary gear set P1, P2, P3.

FIG. 4 shows schematically the drive device with the transmission 1 according to a first embodiment. A good efficiency and a broad transmission range of the transmission 1 are advantageous with this first embodiment. The transmission 1 has the first planetary gear set P1, the second planetary gear set P2, and the third planetary gear set P3. Each of the three planetary gear sets P1, P2, P3 includes a first element E11, E21, E31, a second element E12, E22, E32, and a third element E13, E23, E33. In the present case, the first element E11, E21, E31 of the respective planetary gear set P1, P2, P3 is a sun gear, the second element E12, E22, E32 of the respective planetary gear set P1, P2, P3 is a planet carrier, and the third element E13, E23, E33 of the respective planetary gear set P1, P2, P3 is a ring gear. Each planet carrier carries at least one planetary gear which is in toothed engagement with the sun gear and the ring gear of the respective planetary gear set P1, P2, P3. Consequently, each of the three planetary gear sets P1, P2, P3 is a minus planetary gear set.

The first element E21 of the second planetary gear set P2 is connected to the drive shaft WAn in a rotationally fixed manner, the second element E22 of the second planetary gear set P2 is connected to the first coupling shaft W1 in a rotationally fixed manner, and the third element E23 of the second planetary gear set P2 is connected to the second coupling shaft W2 in a rotationally fixed manner. In the present case, the drive shaft WAn is connected to the drive unit 2 in a rotationally fixed manner. Alternatively, further elements, in particular shafts, gearwheels, switching elements or other devices, may be arranged in the power flow between the drive unit 2 and the drive shaft WAn. For example, the power flow between the drive unit 2 and the drive shaft WAn may be interrupted by such a switching element.

The first element E31 of the third planetary gear set P3 is connected to the first coupling shaft W1 in a rotationally fixed manner, the second element E32 of the third planetary gear set P3 is connected to a stationary component, a housing G, in a rotationally fixed manner, and the third element E33 of the third planetary gear set P3 is connected to the second output shaft WAb2 in a rotationally fixed manner.

The first element E11 of the first planetary gear set P1 is connected to the second coupling shaft W2 in a rotationally fixed manner, the second element E12 of the first planetary gear set P1 is connected to the first output shaft WAb1 in a rotationally fixed manner, and the third element E13 of the first planetary gear set P1 is connected to the second output shaft WAb2 in a rotationally fixed manner.

Consequently, the third element E13 of the first planetary gear set P1 and the third element E33 of the third planetary gear set P3 are connected to one another in a rotationally fixed manner via the second output shaft WAb2. Furthermore, the first coupling shaft W1 connects the second element E12 of the second planetary gear set P2 to the first element E31 of the third planetary gear set P3 in a rotationally fixed manner, and the second coupling shaft W2 connects the third element E23 of the second planetary gear set P2 to the first element E11 of the first planetary gear set P1 in a rotationally fixed manner.

The second planetary gear set P2 is arranged axially between the third planetary gear set P3 and the first planetary gear set P1, wherein the third planetary gear set P3 axially adjoins the drive unit 2. As a result, the drive device is formed in a compact manner. All three planetary gear sets P1, P2, P3 are arranged on a common axis of rotation R. The drive unit 2 is arranged coaxially with respect to the axis of rotation R. The drive shaft WAn is a hollow shaft, wherein the first output shaft WAb1 extends axially through the drive shaft WAn and the drive unit 2. The respective output shaft WAb1, WAb2 is connected to a respective wheel of the motor vehicle in a rotationally fixed manner, for example. Alternatively, the respective output shaft WAb1, WAb2 is connectable to a respective wheel of the motor vehicle indirectly via further transmission elements, in particular spur gear stages, chain drives, or propeller shafts.

The switching element S is configured for transmitting a torque between the second output shaft WAb2 and the second coupling shaft W2. The switching element S in a closed state connects the third element E13 of the first planetary gear set P1 and the first element E11 of the first planetary gear set P1 to one another in a rotationally fixed manner. As a result, the first planetary gear set P1 is blocked. If the switching element S is only partially closed, then only a part of the torque is transmitted between the second coupling shaft W2 and the second output shaft WAb2. As a result of the arrangement of the switching element S in the power flow between the sun gear and the ring gear of the first planetary gear set P1, the first planetary gear set P1 can be at least partially or completely blocked, wherein the torques occurring in the switching element S are then lower than in the case of an arrangement of the switching element S between the two output shafts WAb1, WAb2. Consequently, the switching element S is arranged effectively between the second coupling shaft W2 and the second output shaft WAb2 and acts between the first element E11 of the first planetary gear set P1 and the third element E13 of the first planetary gear set P1. The switching element S is arranged axially adjacent to the first planetary gear set P1. The switching element S is arranged axially between the first planetary gear set P1 and the second planetary gear set P2. Alternatively and not illustrated in the present case, the switching element S can be arranged radially on the outside around the second planetary gear set P2. The second planetary gear set P2 is particularly small in diameter, for example, which has the result that there is space radially between the second planetary gear set P2 and the second output shaft WAb2 for the switching element S. If the switching element S is arranged in a radially nested manner with the second planetary gear set P2, axial overall length is saved.

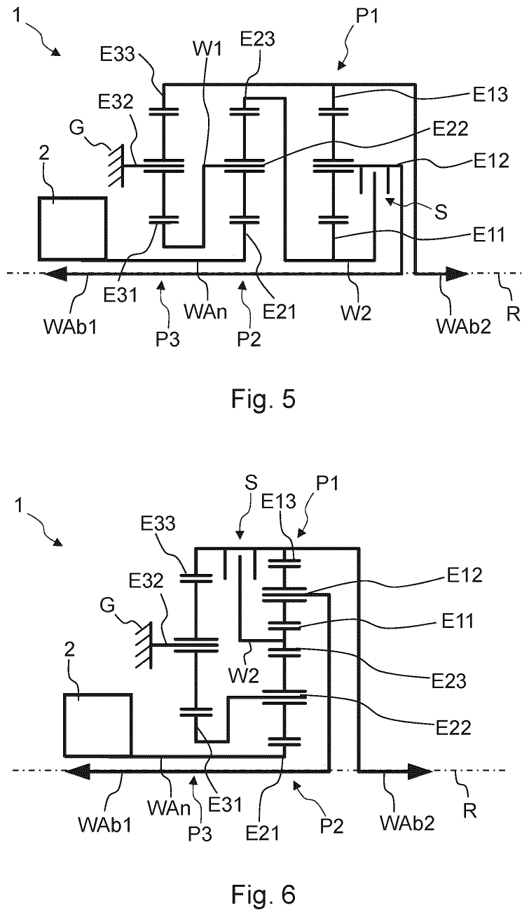

FIG. 5 shows a second embodiment of the drive device according to the invention. The drive device according to FIG. 5 substantially corresponds to the drive device according to FIG. 4, wherein there is a difference between these two embodiments in the arrangement and connection of the switching element S. In the present case, the switching element S is configured for transmitting a torque between the first output shaft WAb1 and the second coupling shaft W2. The switching element S in a closed state connects the second element E12 of the first planetary gear set P1 and the first element E11 of the first planetary gear set P1 in a rotationally fixed manner. Consequently, the switching element S acts between the first element E11 of the first planetary gear set P1 and the second element E12 of the first planetary gear set P1. The switching element S is arranged axially adjacent to the first planetary gear set P1. As a result of the arrangement of the switching element S in the power flow between the sun gear and the planet carrier of the first planetary gear set P1, the first planetary gear set P1 can be at least partially or completely blocked, wherein the torques occurring in the switching element S are then lower than in the case of an arrangement of the switching element S between the two output shafts WAb1, WAb2. Although the torques in the switching element S are higher than in the case of the arrangement of the switching element S in the power flow between the sun gear and the ring gear of the first planetary gear set P1 from FIG. 4, structural advantages result, in particular if the arrangement of the switching element S in the power flow between the sun gear and the ring gear of the first planetary gear set P1 is not structurally possible on account of the binding capability. Otherwise, the exemplary embodiment according to FIG. 5 corresponds to the exemplary embodiment according to FIG. 4, to which reference is made.

FIG. 6 shows a third embodiment of the drive device according to the invention. The drive device according to FIG. 6 substantially corresponds to the drive device according to FIG. 4, however there is a difference between these two embodiments in the arrangement of the first and second planetary gear sets P1, P2. A short axial overall length of the transmission 1 is advantageous with this third embodiment in comparison with the first embodiment. In the present case, the first and second planetary gear sets P1, P2 are arranged in a radially nested manner, wherein the second planetary gear set P2 is arranged radially on the inside, and wherein the first planetary gear set P1 is arranged radially on the outside. Consequently, the second planetary gear set P2 is arranged closer to the axis of rotation R than the first planetary gear set P1. The elements E11, E12, E13 of the first planetary gear set P1 and the elements E21, E22, E23 of the second planetary gear set P2 overlap in the axial direction. The second coupling shaft W2 is configured as an intermediate gear with an internal toothing and an external toothing and connects the first planetary gear set P1 and the second planetary gear set P2. In other words, the third element E23 of the second planetary gear set P2, the first element E11 of the first planetary gear set P1, and the second coupling shaft W2 are formed in one piece as a common component. The internal toothing of the intermediate gear forms a ring gear for the radially inner second planetary gear set P2. The external toothing of the intermediate gear forms a sun gear for the radially outer first planetary gear set P1. The intermediate gear makes the transmission 1 more compact and lighter. Furthermore, the first and third planetary gear sets P1, P3 have a common ring gear. In other words, the third element E13 of the first planetary gear set P1 and the third element E33 of the third planetary gear set P3 are formed as a common component with a single toothing. As a result, the assembly complexity is reduced and the compactness is increased. In particular, the second output shaft WAb2 is formed in one piece with the common ring gear. The switching element S is arranged effectively between the second coupling shaft W2 and the second output shaft WAb2. Consequently, the switching element S acts between the first element E11 of the first planetary gear set P1 and the third element E13 of the first planetary gear set P1. The switching element S is arranged axially adjacent to the third planetary gear set P3. The switching element S is arranged axially between the first planetary gear set P1 and the third planetary gear set P3. Otherwise, the exemplary embodiment according to FIG. 6 corresponds to the exemplary embodiment according to FIG. 4, to which reference is made.

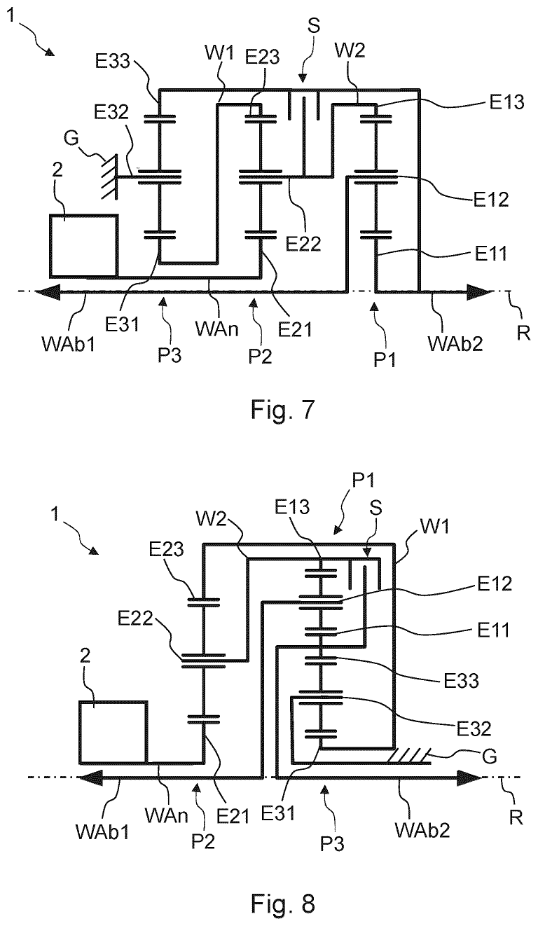

FIG. 7 shows a fourth embodiment of the drive device according to the invention. The drive device according to FIG. 7 substantially corresponds to the drive device according to FIG. 4, however there is a difference between these two embodiments in the connection of the first and second planetary gear sets P1, P2. In the present case, the first element E21 of the second planetary gear set P2 is connected to the drive shaft WAn in a rotationally fixed manner, the second element E22 of the second planetary gear set P2 is connected to the second coupling shaft W2 in a rotationally fixed manner, and the third element E23 of the second planetary gear set P2 is connected to the first coupling shaft W1 in a rotationally fixed manner. The first element E31 of the third planetary gear set P3 is connected to the first coupling shaft W1 in a rotationally fixed manner, the second element E32 of the third planetary gear set P3 is connected to a stationary component, a housing G, in a rotationally fixed manner, and the third element E33 of the third planetary gear set P3 is connected to the second output shaft WAb2 in a rotationally fixed manner. Furthermore, the first element E11 of the first planetary gear set P1 is connected to the second output shaft WAb2 in a rotationally fixed manner, the second element E12 of the first planetary gear set P1 is connected to the first output shaft WAb1 in a rotationally fixed manner, and the third element E13 of the first planetary gear set P1 is connected to the second coupling shaft W2 in a rotationally fixed manner. The switching element S is arranged effectively between the second coupling shaft W2 and the second output shaft WAb2. Consequently, the switching element S acts between the first element E11 of the first planetary gear set P1 and the third element E13 of the first planetary gear set P1. The switching element S is arranged axially adjacent to the first planetary gear set P1. The switching element S is arranged axially between the first planetary gear set P1 and the second planetary gear set P2. Alternatively and not illustrated in the present case, the switching element S can be arranged radially on the outside around the second planetary gear set P2. The second planetary gear set P2 is particularly small in diameter, for example, which has the result that there is space radially between the second planetary gear set P2 and the second output shaft WAb2 for the switching element S. If the switching element S is arranged in a radially nested manner with the second planetary gear set P2, axial overall length is saved. Otherwise, the exemplary embodiment according to FIG. 7 corresponds to the exemplary embodiment according to FIG. 4, to which reference is made.

FIG. 8 shows a fifth embodiment of the drive device according to the invention. The drive device according to FIG. 8 substantially corresponds to the drive device according to FIG. 7, however there is a difference between these two embodiments in the arrangement of the first and third planetary gear sets P1, P3. A short axial overall length of the transmission 1 is advantageous with this fifth embodiment in comparison with the fourth embodiment. In the present case, the first and third planetary gear sets P1, P3 are arranged in a radially nested manner, wherein the third planetary gear set P3 is arranged radially on the inside, and wherein the first planetary gear set P1 is arranged radially on the outside. Consequently, the third planetary gear set P3 is arranged closer to the axis of rotation R than the first planetary gear set P1. The elements E11, E12, E13 of the first planetary gear set P1 and the elements E31, E32, E33 of the third planetary gear set P3 overlap in the axial direction. An intermediate gear with an internal toothing and an external toothing is arranged in the power flow between the first planetary gear set P1 and the third planetary gear set P3. The third element E33 of the third planetary gear set P3, the first element E11 of the first planetary gear set P1, and the second output shaft WAb2 are formed as a common component. The internal toothing forms a ring gear for the radially inner third planetary gear set P3. The external toothing forms a sun gear for the radially outer first planetary gear set P1. The intermediate gear makes the transmission 1 more compact and lighter. The switching element S is arranged effectively between the second coupling shaft W2 and the second output shaft WAb2. Consequently, the switching element S acts between the first element E11 of the first planetary gear set P1 and the third element E13 of the first planetary gear set P1. The switching element S is arranged axially adjacent to the first planetary gear set P1. Otherwise, the exemplary embodiment according to FIG. 8 corresponds to the exemplary embodiment according to FIG. 7, to which reference is made.

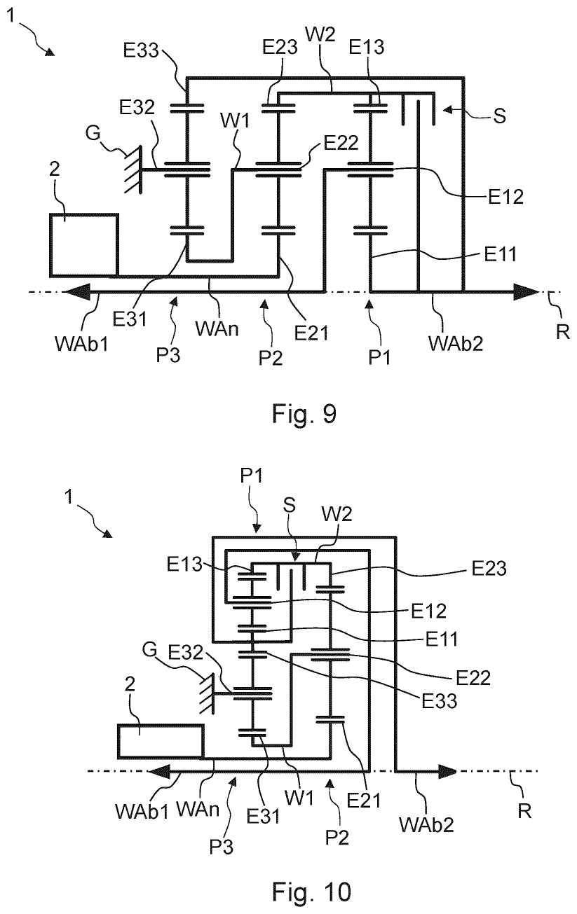

FIG. 9 shows a sixth embodiment of the drive device according to the invention. The drive device according to FIG. 9 substantially corresponds to the drive device according to FIG. 4, however there is a difference between these two embodiments in the connection of the third planetary gear set P3. In the present case, the first element E21 of the second planetary gear set P2 is connected to the drive shaft WAn in a rotationally fixed manner, the second element E22 of the second planetary gear set P2 is connected to the first coupling shaft W1 in a rotationally fixed manner, and the third element E23 of the second planetary gear set P2 is connected to the second coupling shaft W2 in a rotationally fixed manner. The first element E31 of the third planetary gear set P3 is connected to the first coupling shaft W1 in a rotationally fixed manner, the second element E32 of the third planetary gear set P3 is connected to a stationary component, a housing G, in a rotationally fixed manner, and the third element E33 of the third planetary gear set P3 is connected to the second output shaft WAb2 in a rotationally fixed manner. Furthermore, the first element E11 of the first planetary gear set P1 is connected to the second output shaft WAb2 in a rotationally fixed manner, the second element E12 of the first planetary gear set P1 is connected to the first output shaft WAb1 in a rotationally fixed manner, and the third element E13 of the first planetary gear set P1 is connected to the second coupling shaft W2 in a rotationally fixed manner. Furthermore, the first and second planetary gear sets P1, P2 have a common ring gear with a single toothing. In other words, the third element E13 of the first planetary gear set P1, the third element E23 of the second planetary gear set P2, and the second coupling shaft W2 are formed as a common component. As a result, the assembly complexity is reduced and the compactness is increased. The switching element S is arranged effectively between the second coupling shaft W2 and the second output shaft WAb2. Consequently, the switching element S acts between the first element E11 of the first planetary gear set P1 and the third element E13 of the first planetary gear set P1. The switching element S is arranged axially adjacent to the first planetary gear set P1. Otherwise, the exemplary embodiment according to FIG. 9 corresponds to the exemplary embodiment according to FIG. 4, to which reference is made.

FIG. 10 shows a seventh embodiment of the drive device according to the invention. The drive device according to FIG. 10 substantially corresponds to the drive device according to FIG. 9, however there is a difference between these two embodiments in the arrangement of the first and third planetary gear sets P1, P3. A short axial overall length of the transmission 1 is advantageous with this seventh embodiment in comparison with the sixth embodiment. In the present case, the first and third planetary gear sets P1, P3 are arranged in a radially nested manner, wherein the third planetary gear set P3 is arranged radially on the inside, and wherein the first planetary gear set P1 is arranged radially on the outside. Consequently, the third planetary gear set P3 is arranged closer to the axis of rotation R than the first planetary gear set P1. The elements E11, E12, E13 of the first planetary gear set P1 and the elements E31, E32, E33 of the third planetary gear set P3 overlap in the axial direction. An intermediate gear with an internal toothing and an external toothing is arranged in the power flow between the first planetary gear set P1 and the third planetary gear set P3. In the present case, the third element E33 of the third planetary gear set P3 and the first element E11 of the first planetary gear set P1 form a common component. The internal toothing of the intermediate gear forms a ring gear for the radially inner third planetary gear set P3. The external toothing of the intermediate gear forms a sun gear for the radially outer first planetary gear set P1. The intermediate gear makes the transmission 1 more compact and lighter. Furthermore, the first and second planetary gear sets P1, P2 have a common ring gear with a single toothing. In other words, the third element E13 of the first planetary gear set P1, the third element E23 of the second planetary gear set P2, and the second coupling shaft W2 are formed as a common component. As a result, the assembly complexity is reduced and the compactness is increased. The switching element S is arranged effectively between the second coupling shaft W2 and the second output shaft WAb2. Consequently, the switching element S acts between the first element E11 of the first planetary gear set P1 and the third element E13 of the first planetary gear set P1. The switching element S is arranged axially adjacent to the second planetary gear set P2. The switching element S is arranged axially between the first planetary gear set P1 and the second planetary gear set P2. Otherwise, the exemplary embodiment according to FIG. 10 corresponds to the exemplary embodiment according to FIG. 9, to which reference is made.

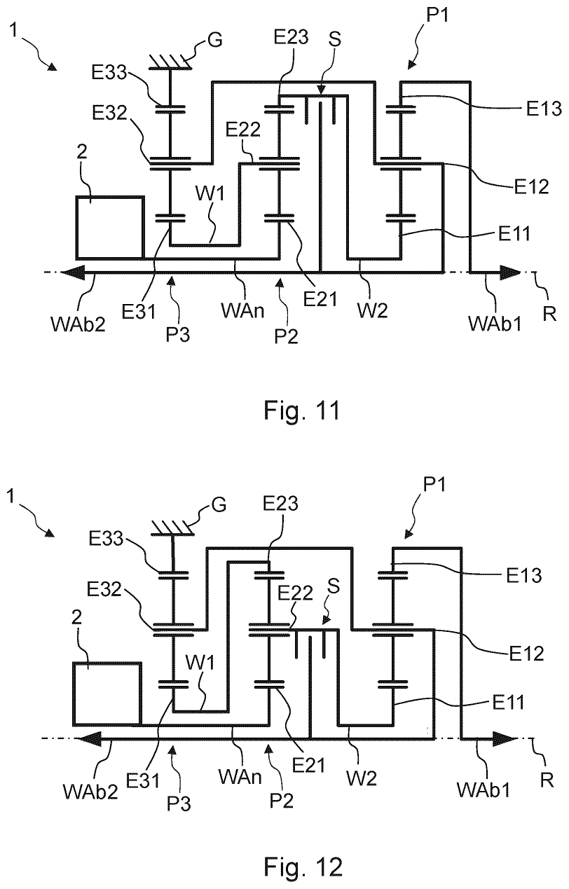

FIG. 11 shows an eighth embodiment of the drive device according to the invention. The drive device according to FIG. 11 substantially corresponds to the drive device according to FIG. 4, however there is a difference between these two embodiments in the connection of the planetary gear sets P1, P2, P3. In the present case, the first element E21 of the second planetary gear set P2 is connected to the drive shaft WAn in a rotationally fixed manner, the second element E22 of the second planetary gear set P2 is connected to the first coupling shaft W1 in a rotationally fixed manner, and the third element E23 of the second planetary gear set P2 is connected to the second coupling shaft W2 in a rotationally fixed manner. The first element E31 of the third planetary gear set P3 is connected to the first coupling shaft W1 in a rotationally fixed manner, the second element E32 of the third planetary gear set P3 is connected to the second output shaft WAb2 in a rotationally fixed manner, and the third element E33 of the third planetary gear set P3 is connected to a stationary component, a housing G, in a rotationally fixed manner. Furthermore, the first element E11 of the first planetary gear set P1 is connected to the second coupling shaft W2 in a rotationally fixed manner, the second element E12 of the first planetary gear set P1 is connected to the second output shaft WAb2 in a rotationally fixed manner, and the third element E13 of the first planetary gear set P1 is connected to the first output shaft WAb1 in a rotationally fixed manner. The drive shaft WAn is a hollow shaft, wherein the second output shaft WAb2 extends axially through the drive shaft WAn and the drive unit 2. The switching element S is arranged effectively between the second coupling shaft W2 and the second output shaft WAb2. Consequently, the switching element S acts between the first element E11 of the first planetary gear set P1 and the second element E12 of the first planetary gear set P1. The switching element S is arranged axially adjacent to the first planetary gear set P1. The switching element S is arranged axially between the first planetary gear set P1 and the second planetary gear set P2. Alternatively and not illustrated in the present case, the switching element S can be arranged radially on the outside around the second planetary gear set P2. The second planetary gear set P2 is particularly small in diameter, for example, which has the result that there is space radially between the second planetary gear set P2 and the second output shaft WAb2 for the switching element S. If the switching element S is arranged in a radially nested manner with the second planetary gear set P2, axial overall length is saved. Otherwise, the exemplary embodiment according to FIG. 11 corresponds to the exemplary embodiment according to FIG. 4, to which reference is made.

FIG. 12 shows a ninth embodiment of the drive device according to the invention. The drive device according to FIG. 12 substantially corresponds to the drive device according to FIG. 4, however there is a difference between these two embodiments in the connection of the planetary gear sets P1, P2, P3. In the present case, the first element E21 of the second planetary gear set P2 is connected to the drive shaft WAn in a rotationally fixed manner, the second element E22 of the second planetary gear set P2 is connected to the second coupling shaft W2 in a rotationally fixed manner, and the third element E23 of the second planetary gear set P2 is connected to the first coupling shaft W1 in a rotationally fixed manner. The first element E31 of the third planetary gear set P3 is connected to the first coupling shaft W1 in a rotationally fixed manner, the second element E32 of the third planetary gear set P3 is connected to the second output shaft WAb2 in a rotationally fixed manner, and the third element E33 of the third planetary gear set P3 is connected to a stationary component, a housing G, in a rotationally fixed manner. Furthermore, the first element E11 of the first planetary gear set P1 is connected to the second coupling shaft W2 in a rotationally fixed manner, the second element E12 of the first planetary gear set P1 is connected to the second output shaft WAb2 in a rotationally fixed manner, and the third element E13 of the first planetary gear set P1 is connected to the first output shaft WAb1 in a rotationally fixed manner. The drive shaft WAn is a hollow shaft, wherein the second output shaft WAb2 extends axially through the drive shaft WAn and the drive unit 2. The switching element S is arranged effectively between the second coupling shaft W2 and the second output shaft WAb2. Consequently, the switching element S acts between the first element E11 of the first planetary gear set P1 and the second element E12 of the first planetary gear set P1. The switching element S is arranged axially adjacent to the first planetary gear set P1. The switching element S is arranged axially between the first planetary gear set P1 and the second planetary gear set P2. Alternatively and not illustrated in the present case, the switching element S can be arranged radially on the outside around the second planetary gear set P2. The second planetary gear set P2 is particularly small in diameter, for example, which has the result that there is space radially between the second planetary gear set P2 and the second output shaft WAb2 for the switching element S. If the switching element S is arranged in a radially nested manner with the second planetary gear set P2, axial overall length is saved. Otherwise, the exemplary embodiment according to FIG. 12 corresponds to the exemplary embodiment according to FIG. 4, to which reference is made.

According to all nine exemplary embodiments, the transmission 1 has the first planetary gear set P1, which is a minus planetary gear set with a sun gear, a ring gear and a planet carrier, the drive shaft WAn, which is configured for connecting the transmission 1 to the drive unit 2, the first output shaft WAb1 and the second output shaft WAb2, which are each configured for connecting the transmission 1 to a wheel of the motor vehicle, and the switching element S. One of the elements E11, E12, E13 of the first planetary gear set P1 is always connected to the first output shaft WAb1 in a rotationally fixed manner, wherein another of the elements E11, E12, E13 of the first planetary gear set P1 is always connected to the second output shaft WAb2 in a rotationally fixed manner, and wherein another of the elements E11, E12, E13 of the first planetary gear set P1 is always connectable to one of the two output shafts WAb1, WAb2 via the switching element S.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE SIGNS

1 transmission
2 drive unit
W1 first coupling shaft
W2 second coupling shaft
WAn input shaft
WAb1 first output shaft
WAb2 second output shaft
G housing
S switching element
R axis of rotation
P1 first planetary gear set
E11 first element of the first planetary gear set
E12 second element of the first planetary gear set
E13 third element of the first planetary gear set
P2 second planetary gear set
E21 first element of the second planetary gear set
E22 second element of the second planetary gear set
E23 third element of the second planetary gear set
P3 third planetary gear set
E31 first element of the third planetary gear set
E32 second element of the third planetary gear set
E33 third element of the third planetary gear set
100 motor vehicle
101 first wheel axle
102 second wheel axle
R1 wheel
R2 wheel
R3 wheel
R4 wheel

1-15. (canceled)

16. A transmission (1) for a motor vehicle (100), comprising:
exactly one drive shaft (WAn) connecting the transmission (1) to a drive unit (2) of the motor vehicle (100);
a first output shaft (WAb1) connecting the transmission (1) to a wheel (R1) of the motor vehicle (100);
a second output shaft (WAb2) connecting the transmission (1) to another wheel (R2) of the motor vehicle (100);
a first coupling shaft (W1);
a second coupling shaft (W2);
a switching element(S) for transmitting a torque between the second coupling shaft (W2) and one of the first output shaft (WAb1) or the second output shaft (WAb2);
a first planetary gear set (P1) having first gear set elements (E11, E12, E13), one of the first gear set elements (E11, E12, E13) being rotationally fixedly connected to the second coupling shaft (W2), another of the first gear set elements (E11, E12, E13) being rotationally fixedly connected to the first output shaft (WAb1), and a further one of the first gear set elements (E11, E12, E13) being rotationally fixedly connected to the second output shaft (WAb2);
a second planetary gear set (P2) having second gear set elements (E21, E22, E23), one of the second gear set elements (E21, E22, E23) being rotationally fixedly connected to the drive shaft (WAn), another of the second gear set elements (E21, E22, E23) being rotationally fixedly connected to the first coupling shaft (W1), and a further one of the second gear set elements (E21, E22, E23) being rotationally fixedly connected to the second coupling shaft (W2); and
a third planetary gear set (P3) having third gear set elements (E31, E32, E33), one of the third gear set elements (E31, E32, E33) being rotationally fixedly connected to the first coupling shaft (W1), another of the third gear set elements (E31, E32, E33) being rotationally fixedly connected to a stationary component, and a further one of the third gear set elements (E31, E32, E33) being rotationally fixedly connected to the second output shaft (WAb2),
wherein the first gear set elements (E11, E12, E13), the second gear set elements (E21, E22, E23), and the third gear set elements (E31, E32, E33) each comprise a respective set including a first element (E11, E21, E31), a second element (E12, E22, E32) and a third element (E13, E23, E33).

17. The transmission according to claim 16,
wherein the first element (E21) of the second planetary gear set (P2) is rotationally fixedly connected to the drive shaft (WAn), the second element (E22) of the second planetary gear set (P2) is rotationally fixedly connected to the first coupling shaft (W1), and the third element (E23) of the second planetary gear set (P2) is rotationally fixedly connected to the second coupling shaft (W2),
wherein the first element (E31) of the third planetary gear set (P3) is rotationally fixedly connected to the first coupling shaft (W1), the second element (E32) of the third planetary gear set (P3) is rotationally fixedly connected to a stationary component, and the third element (E33) of the third planetary gear set (P3) is rotationally fixedly connected to the second output shaft (WAb2),
wherein the first element (E11) of the first planetary gear set (P1) is rotationally fixedly connected to the second coupling shaft (W2), the second element (E12) of the first planetary gear set (P1) is rotationally fixedly connected to the first output shaft (WAb1), and the third element (E13) of the first planetary gear set (P1) is rotationally fixedly connected to the second output shaft (WAb2).

18. The transmission (1) according to claim 16,
wherein the first element (E21) of the second planetary gear set (P2) is rotationally fixedly connected to the drive shaft (WAn), the second element (E22) of the second planetary gear set (P2) is rotationally fixedly connected to the second coupling shaft (W2), and the third element (E23) of the second planetary gear set (P2) is rotationally fixedly connected to the first coupling shaft (W1),
wherein the first element (E31) of the third planetary gear set (P3) is rotationally fixedly connected to the first coupling shaft (W1), the second element (E32) of the third planetary gear set (P3) is rotationally fixedly connected to a stationary component, and the third element (E33) of the third planetary gear set (P3) is rotationally fixedly connected to the second output shaft (WAb2), and
wherein the first element (E11) of the first planetary gear set (P1) is rotationally fixedly connected to the second output shaft (WAb2), the second element (E12) of the first planetary gear set (P1) is rotationally fixedly connected to the first output shaft (WAb1), and the third element (E13) of the first planetary gear set (P1) is rotationally fixedly connected to the second coupling shaft (W2).

19. The transmission (1) according to claim 16,
wherein the first element (E21) of the second planetary gear set (P2) is rotationally fixedly connected to the drive shaft (WAn), the second element (E22) of the second planetary gear set (P2) is rotationally fixedly connected to the first coupling shaft (W1), and the third element (E23) of the second planetary gear set (P2) is rotationally fixedly connected to the second coupling shaft (W2),
wherein the first element (E31) of the third planetary gear set (P3) is rotationally fixedly connected to the first coupling shaft (W1), the second element (E32) of the third planetary gear set (P3) is rotationally fixedly connected to a stationary component, and the third element (E33) of the third planetary gear set (P3) is rotationally fixedly connected to the second output shaft (WAb2),
wherein the first element (E11) of the first planetary gear set (P1) is rotationally fixedly connected to the second output shaft (WAb2), the second element (E12) of the first planetary gear set (P1) is rotationally fixedly connected to the first output shaft (WAb1), and the third element (E13) of the first planetary gear set (P1) is rotationally fixedly connected to the second coupling shaft (W2).

20. The transmission (1) according to claim 16,
wherein the first element (E21) of the second planetary gear set (P2) is rotationally fixedly connected to the drive shaft (WAn), the second element (E22) of the second planetary gear set (P2) is rotationally fixedly connected to the first coupling shaft (W1), and the third element (E23) of the second planetary gear set (P2) is rotationally fixedly connected to the second coupling shaft (W2),
wherein the first element (E31) of the third planetary gear set (P3) is rotationally fixedly connected to the first coupling shaft (W1), wherein the second element (E32) of the third planetary gear set (P3) is rotationally fixedly connected to the second output shaft (WAb2), and the third element (E33) of the third planetary gear set (P3) is rotationally fixedly connected to a stationary component,
wherein the first element (E11) of the first planetary gear set (P1) is rotationally fixedly connected to the second coupling shaft (W2), the second element (E12) of the first planetary gear set (P1) is rotationally fixedly connected to the second output shaft (WAb2), and the third element (E13) of the first planetary gear set (P1) is rotationally fixedly connected to the first output shaft (WAb1).

21. The transmission (1) according to claim 16,
wherein the first element (E21) of the second planetary gear set (P2) is rotationally fixedly connected to the drive shaft (WAn), the second element (E22) of the second planetary gear set (P2) is rotationally fixedly connected to the second coupling shaft (W2), and the third element (E23) of the second planetary gear set (P2) is rotationally fixedly connected to the first coupling shaft (W1),
wherein the first element (E31) of the third planetary gear set (P3) is rotationally fixedly connected to the first coupling shaft (W1), the second element (E32) of the third planetary gear set (P3) is rotationally fixedly connected to the second output shaft (WAb2), and the third element (E33) of the third planetary gear set (P3) is rotationally fixedly connected to a stationary component,
wherein the first element (E11) of the first planetary gear set (P1) is rotationally fixedly connected to the second coupling shaft (W2), the second element (E12) of the first planetary gear set (P1) is rotationally fixedly connected to the second output shaft (WAb2), and the third element (E13) of the first planetary gear set (P1) is rotationally fixedly connected to the first output shaft (WAb1).

22. The transmission (1) according to claim 16, wherein two of the first, second, and third planetary gear sets (P1, P2, P3) are radially nested.

23. The transmission (1) according to claim 16, wherein one of the first and second coupling shafts (W1, W2) or one of the first and second output shafts (WAb1, WAb2) is formed in one piece with each element of the first, second, and third planetary gear sets (P1, P2, P3) connected to the one of the first and second coupling shafts (W1, W2) or the one of the first and second output shafts (WAb1, WAb2).

24. The transmission (1) according to claim 16, wherein at least one of the first, second, and third planetary gear sets (P1, P2, P3) is a minus planetary gear set, the first element (E11, E21, E31) of the minus planetary gear set (P1, P2, P3) being a sun gear, the second element (E12, E22, E32) of the minus planetary gear set (P1, P2, P3) being a planet carrier, and the third element (E13, E23, E33) of the minus planetary gear set (P1, P2, P3) being a ring gear.

25. The transmission (1) according to claim 16, wherein the switching element(S) is a friction clutch or a claw clutch.

26. The transmission (1) according to claim 16, wherein an axial force results from a helical toothing, an actuation of the switching element(S) occurs at least partially by the axial force.

27. The transmission (1) according to claim 16, wherein the switching element(S) in a closed state rotationally fixedly connects the third element (E13) of the first planetary gear set (P1) and the first element (E11) of the first planetary gear set (P1).

28. The transmission (1) according to claim 16, wherein the switching element(S) in a closed state rotationally fixedly connects the second element (E12) of the first planetary gear set (P1) and the first element (E11) of the first planetary gear set (P1).

29. A drive device, comprising:
the drive unit (2); and
the transmission (1) of claim 16.

30. A transmission (1) for a motor vehicle (100), comprising:
a first planetary gear set (P1) having first gear set elements including a first element (E11), a second element (E12), and a third element (E13), the first planetary gear set (P1) being a minus planetary gear set;
a drive shaft (WAn) for connecting the transmission (1) to a drive unit (2) of the motor vehicle (100);
a first output shaft (WAb1) connecting the transmission (1) to a wheel (R1, R2) of the motor vehicle (100);
a second output shaft (WAb2) connecting the transmission (1) to another wheel (R1, R2) of the motor vehicle (100); and
a switching element(S),
wherein one of the first gear set elements (E11, E12, E13) of the first planetary gear set (P1) is rotationally fixedly connected to the first output shaft (WAb1), another of the first gear set elements (E11, E12, E13) of the first planetary gear set (P1) is rotationally fixedly connected to the second output shaft (WAb2), and a further one of the first gear set elements (E11, E12, E13) of the first planetary gear set (P1) is connectable to one of the first and second output shafts (WAb1, WAb2) via the switching element(S).

31. The transmission (1) according to claim 30, wherein the switching element(S) is a friction clutch or a claw clutch.

32. The transmission (1) according to claim 30, wherein an axial force results from a helical toothing, an actuation of the switching element(S) occurs at least partially by the axial force.

33. The transmission (1) according to claim 30, wherein the switching element(S) in a closed state rotationally fixedly connects the third element (E13) of the first planetary gear set (P1) and the first element (E11) of the first planetary gear set (P1).

34. The transmission (1) according to claim 30, wherein the switching element(S) in a closed state rotationally fixedly connects the second element (E12) of the first planetary gear set (P1) and the first element (E11) of the first planetary gear set (P1).

35. A drive device, comprising:
the drive unit (2); and
the transmission (1) of claim 30.
